(19) United States
(12) Patent Application Publication
(10) Pub. No.: US 2022/0384836 A1
(43) Pub. Date: Dec. 1, 2022

(54) FUEL CELL DEVICE

(71) Applicant: Robert Bosch GmbH, Stuttgart (DE)

(72) Inventors: Jochen Winkler, Esslingen (DE); Martin Hoeller, Stuttgart (DE); Peter Horstmann, Leonberg (DE); Sebastian Obermeyer, Stuttgart (DE); Tobias Zimmer, Nonnweiler-Primstal (DE); Bertram Schweitzer, Esslingen (DE)

(21) Appl. No.: 17/765,501

(22) PCT Filed: Sep. 28, 2020
(86) PCT No.: PCT/EP2020/077047

§ 371 Date: Mar. 31, 2022

(30) Foreign Application Priority Data
Oct. 2, 2019 (DE) 10 2019 215 230.9

(51) Int. Cl. H01M 8/2483

(52) U.S. Cl. CPC H01M 8/2483

(57) ABSTRACT

The invention relates to a fuel cell device (10), comprising at least one fuel cell stack (12) and at least one processing unit (14). According to the invention, a distribution manifold (60) for carrying media is disposed between the at least one fuel cell stack (12) and the at least one processing unit (14).

### BACKGROUND

The present invention relates to a fuel cell device comprising at least one fuel cell stack and at least one processor unit.

Fuel cell devices which have a fuel cell stack and a processor unit are already known.

### SUMMARY

The present invention has the advantage over the prior art that a distributor plate for guiding media is arranged between the at least one fuel cell stack and the at least one processor unit. This allows an improved and more compact design of the fuel cell device.

In the context of this invention, a “processor unit” should be understood, in particular, to mean a unit or component of the fuel cell device which is not a fuel cell and/or a fuel cell stack. In particular, the processor unit is a unit for the, preferably chemical and/or thermal, preparation and/or after-treatment of at least one medium which is to be converted and/or has been converted in the at least one fuel cell stack, such as, for example, a fuel gas, an air and/or an exhaust gas. The processor unit is preferably a reformer, an afterburner and/or a heat exchanger.

It is advantageous if the at least one fuel cell stack and the at least one processor unit are arranged spatially separated from one another, thereby improving accessibility to individual components, for example during maintenance.

It is also advantageous if the distributor plate connects the at least one processor unit to the at least one fuel cell stack in terms of flow. It is thereby possible to create a compact fluidic connection between the at least one processor unit and the fuel cell stack, while at the same time reducing the variety of parts.

It is also advantageous if the distributor plate has, between two component plates, media ducts, formed spatially separated from one another, for at least one medium which is to be converted and/or has been converted in the at least one fuel cell stack, thereby making it possible to achieve particularly good media ducting.

It is also advantageous if the distributor plate is of one-piece design, preferably being designed as a casting, thereby making it possible to reduce production costs.

### BRIEF DESCRIPTION OF THE DRAWINGS

Exemplary embodiments of the invention are illustrated schematically in the drawings and explained in greater detail in the following description. In the drawings:

FIG. 1 shows a schematic circuit diagram of an exemplary embodiment of a fuel cell device,

FIG. 2 shows a perspective illustration of the exemplary embodiment of the fuel cell device from FIG. 1,

FIG. 3 shows a further perspective illustration of the exemplary embodiment of the fuel cell device from the preceding figures,

FIG. 4 shows an enlarged illustration of a lower region of the exemplary embodiment of the fuel cell device from the preceding figures,

FIG. 5 shows a cross section of the lower region of the exemplary embodiment of the fuel cell device from the preceding figures with schematically illustrated flows of various media,

FIG. 6 shows a plan view of a distributor plate of the exemplary embodiments of the fuel cell device from the preceding figures.

### DETAILED DESCRIPTION

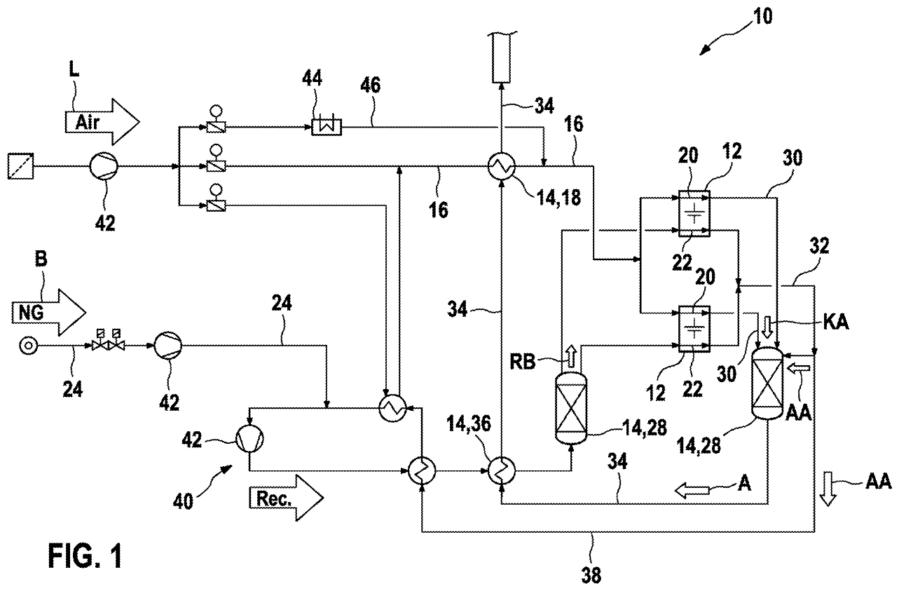

FIG. 1 shows a schematic circuit diagram of an exemplary embodiment of a fuel cell device 10. The fuel cell device 10 comprises two fuel cell stacks 12, which have a multiplicity of fuel cells, in the present case solid oxide fuel cells (SOFC), and a multiplicity of processor units 14.

In the context of this invention, a “processor unit” 14 should be understood, in particular, to mean a unit or component of the fuel cell device 10 which is not a fuel cell and/or a fuel cell stack 12. In the present case, the processor units 14 are units for the chemical and/or thermal preparation and/or after-treatment of at least one medium which is to be converted and/or has been converted in the fuel cell stacks 12, such as, for example, a fuel gas, an air and/or an exhaust gas.

One of the processor units 14 is a heat exchanger 18, arranged in an air feed 16, for heating an air L fed to the fuel cell stacks 12. In the present case, the air L is fed, in normal operation for example, in each case to a cathode space 20 of the fuel cell stacks 12, while reformed fuel RB, in the present case hydrogen, is fed in each case to a cathode space 22. In the fuel cell stacks 12, the reformed fuel is electrochemically converted in order to generate electric current and heat.

The reformed fuel RB is produced by feeding fuel B, in the present case natural gas, to the fuel cell device 10 via a fuel feed 24, which fuel is reformed in a further processor unit 14, in the present case a reformer 26.

Furthermore, the fuel cell stacks 12 are connected on the exhaust gas side to a further processor unit 14, in the present case to an afterburner 28. Exhaust gas from the fuel cell stacks 12 is fed to the afterburner 28, in the present case in each case cathode exhaust gas KA being fed via a cathode exhaust gas duct 30, and anode exhaust gas AA being fed via an anode exhaust gas duct 32. The cathode exhaust gas contains predominantly unused air L, while anode exhaust gas AA contains unconverted fuel B, among other components. By means of the afterburner 28, the anode exhaust gas AA, or the unconverted fuel B contained therein, is burnt with the admixture of the cathode exhaust gas KA, or the air L contained therein, thereby making it possible to generate additional heat.

The hot exhaust gas A produced during combustion in the afterburner 28 is removed from the afterburner 28 by means of an exhaust gas duct 34 via a further processor unit 14, in the present case via a heat exchanger 36. In this case, the heat exchanger 36 is in turn fluidically connected to the reformer 26, with the result that heat is transferred from the hot exhaust gas A to the fuel B fed to the reformer 26. Accordingly, the heat of the hot exhaust gas A can be used for reforming of the supplied fuel B in the reformer 26.

Downstream of heat exchanger 36 there is a further processor unit 14, in the present case heat exchanger 18, in the exhaust gas duct 34, thus enabling the residual heat of the hot exhaust gas A to be transferred to the supplied air L in the air feed 16. Accordingly, the residual heat of the hot exhaust gas can be used to preheat the supplied air L in the air duct 16.

In addition, the fuel cell device 10 has a return 38, by means of which some of the anode exhaust gas AA can be branched off from the anode exhaust gas line 30 and fed to the fuel feed 22. Together with the fuel feed 22, the return line 34 thus forms an anode recirculation circuit 40, by means of which anode exhaust gas AA can be returned to the anode of the fuel cell 12, thus enabling any unconverted fuel B in the anode exhaust gas AA to be subsequently converted, thereby making it possible to further increase the efficiency of the fuel cell device 10.

The supply of air L in the air feed 16, the supply of fuel B in the fuel feed 24 and the recirculation rate of the anode exhaust gas AA in the anode recirculation circuit 40 can be controlled and/or matched to one another by means of compressors 42 in the respective lines.

Furthermore, the fuel cell device has a heating element 44 for, in the present case additionally, heating the air L fed to the fuel cell stacks 12 in a bypass line 46, thereby increasing the operating efficiency of the fuel cell device 10.

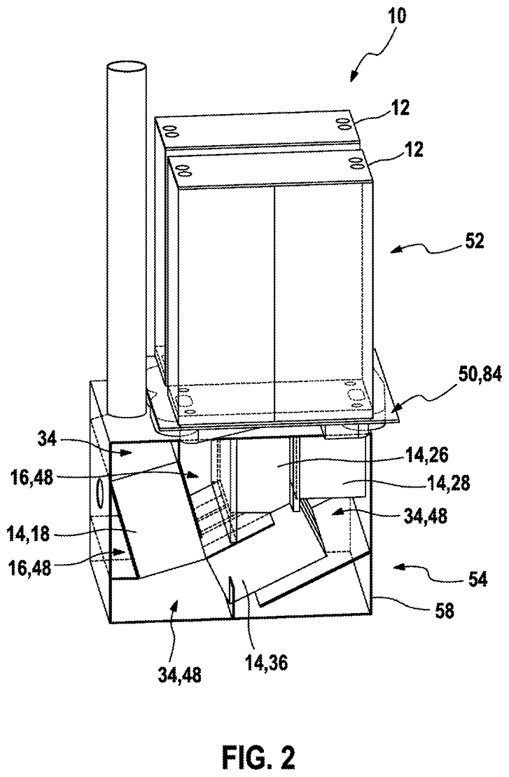

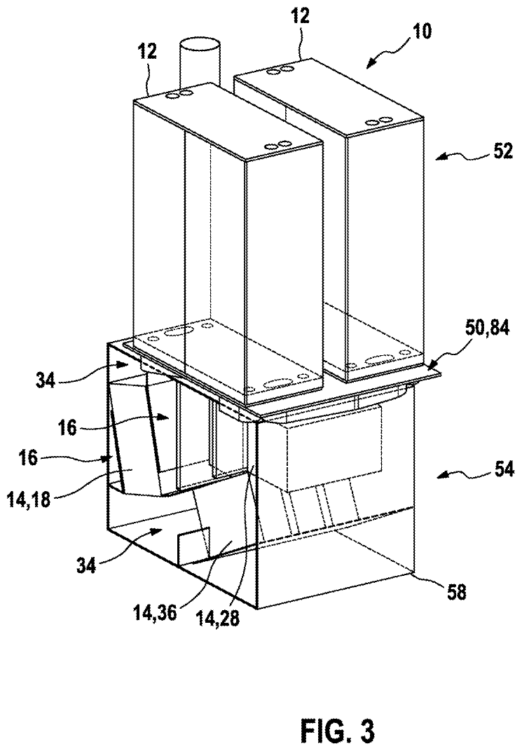

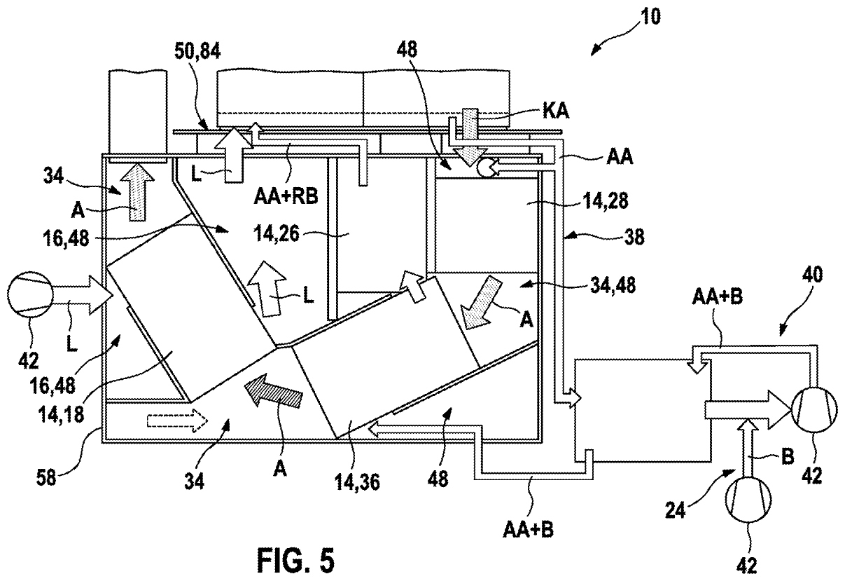

FIGS. 2-4 show perspective illustrations of an exemplary embodiment of a fuel cell device 10, and FIG. 5 shows a cross section of a lower region of the fuel cell device 10. The illustrations show a specific implementation of the fuel cell device 10 in accordance with the circuit diagram in FIG. 1.

As already explained, the processor units 14 are a reformer 26, an afterburner 28 and two heat exchangers 18, 36. It can be seen from FIGS. 2-5 that the processor units 14 are arranged in such a way, in the present case on their edges, that media ducting spaces which are separated from one another are formed at or between the processor units 14. Thus, the air feed 16 and the exhaust gas duct 34 are designed at least substantially as media ducting spaces 48. As a result, no piping is required between the processor units 14, thereby, on the one hand, simplifying assembly on and, on the other hand, reducing the variety of parts.

The fuel cell device is then distinguished by the fact that a distributor plate 50 for guiding media is arranged between the fuel cell stacks 12 and the processor units 14. It is thereby possible to achieve a compact design of the fuel cell device 10. In addition, the connection or assembly of the fuel cell stacks 12 to the processor units 14 is simplified. Moreover, here too, no piping is required between the fuel cell stacks 12 and the processor units 14, thereby reducing the variety of parts.

In the case shown, fuel cell stacks 12 and the processor units 14 are arranged spatially separated from one another, thereby improving accessibility to individual components, for example during maintenance. In the case shown, the fuel cells 12 are arranged in an upper region 52, while the processor units are arranged in a lower region 54. For improved illustration, the fuel cell device is shown as being substantially open. In actual fact, the fuel cell stacks 12 are installed in a first housing (not illustrated) and the processor units 14 are installed in a second housing 58. Together with the processor units 14, the second housing 58 forms the media ducts or media ducting spaces 48 for the media which are to be converted and/or have been converted in the fuel cell stacks, such as the fuel B, reformed fuel RB, the air L, the cathode exhaust gas KA, the anode exhaust gas AA and/or the exhaust gas A.

In terms of flow, the distributor plate 50 then connects the processor units 14 to the fuel cell stacks 12, thereby providing a particularly elegant and compact fluidic connection.

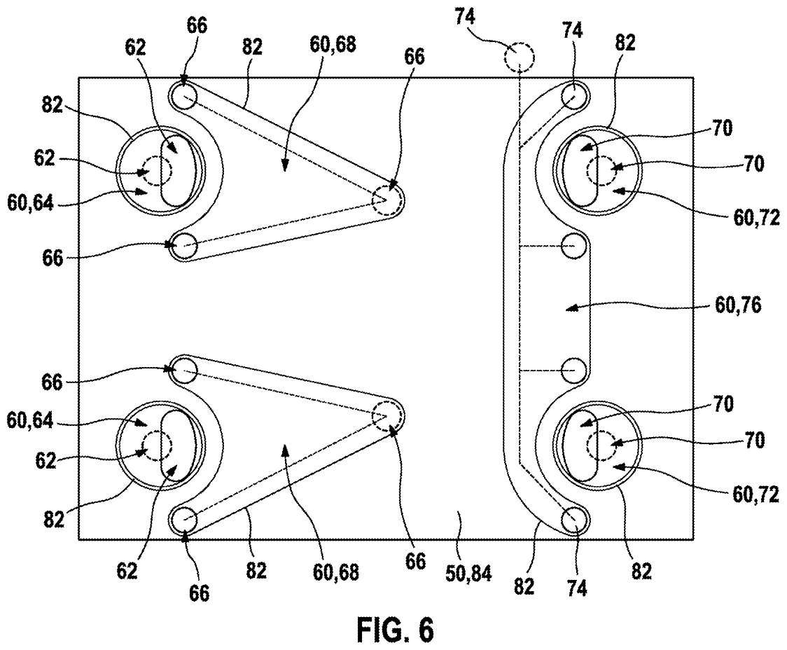

Between two component plates arranged at a distance from one another and formed separately from one another, the distributor plate has media ducts 60 for the media which are to be converted and/or have been converted in the fuel cell stacks 12. FIG. 6 correspondingly shows a plan view of the distributor plate 50.

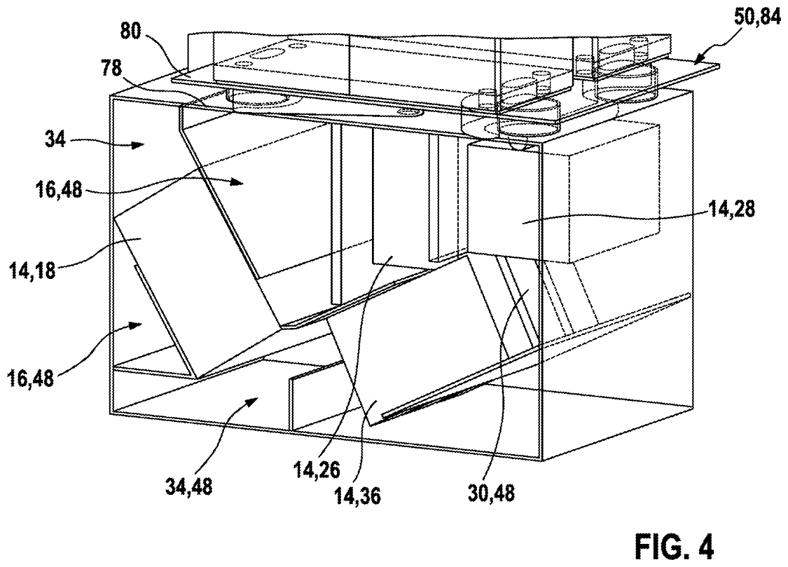

In the case shown, the distributor plate 50 has openings 62 and associated media ducts 64 for the air L fed to the fuel cell stacks 12, openings 66 and associated media ducts 68 for the reformed fuel RB fed to the fuel cell stacks 12 and the anode exhaust gas AA (containing unconverted fuel B) coming from the anode recirculation circuit 40, openings 70 and associated media ducts 72 for the cathode exhaust gas KA discharged from the fuel cell stacks 12, as well as openings 74 and an associated media duct 76 for the anode exhaust gas AA discharged from the fuel cell stacks 12. Here, the openings illustrated in dashed lines are made in a first (lower) component plate 78, while the openings illustrated in solid lines are made in a second (upper) component plate 80 (cf. FIG. 4 and FIG. 5). In this case, the media ducts 60 are formed between the openings made in the first (lower) component plate 78 and the associated openings made in the second (upper) component plate 80. In this case, the media ducts 60 are laterally bordered and sealed by walls 82. In turn, the walls 82 space apart the first (lower) component plate 78 and the second (upper) component plate, thereby, despite the compactness, creating space for any further feed and/or discharge lines, which can, for example, also be connected and/or introduced from the outside. The connections of the fuel cell stacks 12 and the connections of the second component housing 84, which has the processor units 14, can also be matched to one another by means of the distributor plate 50, or by means of the media ducts 60 introduced into the distributor plate. In this way, it is possible to use different types of fuel cell stack 12, as required, by adapting the media ducts 60.

In the exemplary embodiment shown, the distributor plate 50 is of one-piece design, preferably being designed as a casting, thereby reducing production costs. Alternatively, however, it would also be possible for the distributor plate 50 to be welded together from sheet metal parts and/or to be produced by 3D printing.

1. A fuel cell device (10), comprising at least one fuel cell stack (12) and at least one processor unit (14), wherein a distributor plate (50) for guiding media is arranged between the at least one fuel cell stack (12) and the at least one processor unit (14).

2. The fuel cell device (10) as claimed in claim 1, wherein the at least one fuel cell stack (12) and the at least one processor unit (14) are arranged spatially separated from one another.

3. The fuel cell device as claimed in claim 1, wherein the distributor plate connects the at least one processor unit (14) to the at least one fuel cell stack (12) in terms of flow.

4. The fuel cell device (10) as claimed in claim 1, wherein the distributor plate (50) has, between two component plates (78, 80), media ducts (60), formed spatially separated from one another, for at least one medium which is to be converted and/or has been converted in the at least one fuel cell stack (12).

5. The fuel cell device as claimed in claim 1, wherein the distributor plate (50) is of one-piece design.

6. The fuel cell device as claimed in claim 5, wherein the distributor plate (50) is a casting.
